(19) United States
(12) Patent Application Publication
(10) Pub. No.: US 2024/0061952 A1
(43) Pub. Date: Feb. 22, 2024

(54) IDENTIFYING SENSITIVE DATA USING REDACTED DATA

(71) Applicant: Capital One Services, LLC, McLean, VA (US)

(72) Inventors: Jennifer Kwok, Brooklyn, NY (US); John Martin, Brooklyn, NY (US); James Crews, Washington, DC (US); Erin Babinsky, Arlington, VA (US); Shannon Yogerst, New York, NY (US); Ignacio Espino, Arlington, VA (US); Dwipam Katariya, McClean, VA (US); Mia Rodriguez, Broomfield, CO (US); Nima Chitsazan, Ridgefield, NJ (US); Max Miracolo, Brooklyn, NY (US)

(21) Appl. No.: 17/892,346

(22) Filed: Aug. 22, 2022

(51) Int. Cl. G06F 21/62; G06F 40/174; G06F 40/40

(52) U.S. Cl. CPC G06F 21/6245; G06F 40/174; G06F 40/40

(57) ABSTRACT

Disclosed embodiments pertain to identifying sensitive data using redacted data. Data entry into electronic form fields can be monitored and analyzed to detect improperly entered sensitive data. The type of sensitive data can be determined, and the sensitive data can be removed or redacted from the electronic form field. Surrounding context data, including text associated with the sensitive data, can be identified and captured. The context data and type of sensitive data can be utilized to train or update a machine learning model configured to identify sensitive data. In one instance, the machine learning model can be employed to detect improperly entered sensitive data, and context and type can be utilized to improve the performance and predictive power of the machine learning model.

### BACKGROUND

Customer service representatives/agents and customers (e.g., users) can accidentally enter sensitive information (e.g., sensitive information), such as personally identifiable information (PII), into wrong form fields or other wrong locations in electronic documents. For example, customers and agents have been found prone to enter social security numbers (SSNs) and credit card numbers into incorrect portions including the note fields of electronic documents. Customers have also accidentally filled in their user names with their SSN or credit card number. Customers also incorrectly enter sensitive information such as PII in a number of other unconventional ways. When entered incorrectly, this unmasked sensitive information may end up being transmitted without proper encryption and may not be properly encrypted and stored. Such a situation may violate federal and international regulations requiring sensitive information and PII to be properly transmitted and stored with adequate safety measures. When an organization violates one or more regulations, that organization may suffer from a damaged reputation. If an organization is known by the public to violate regulations regarding proper handling of sensitive information and PII, that organization may suffer from lost public trust and eventually lose economically from the loss of business from a reduced customer base.

### SUMMARY

The following presents a simplified summary to provide a basic understanding of some aspects of the disclosed subject matter. This summary is not an extensive overview. It is not intended to identify necessary elements or to delineate the scope of the claimed subject matter. Rather, this summary presents some concepts in a simplified form as a prelude to the more detailed description presented later.

According to one aspect, disclosed embodiments can include a system that comprises a processor coupled to a memory that includes instructions that, when executed by the processor, cause the processor to detect entry of sensitive data in an electronic form field in substantially real-time, determine a sensitive data type associated with the sensitive data, redact the sensitive data from the electronic form field, identify context data surrounding redacted sensitive data in the electronic form field, and train a machine learning model with the context data and sensitive data type to identify sensitive data. Further, the instructions can cause the processor to perform pattern matching to detect the entry of sensitive data into the electronic form field. In one instance, the electronic form field can be a freeform note field. Additionally, the machine learning model can detect entry of the sensitive data in the electronic form field and be retrained with the context data and the sensitive data type. In one embodiment, the machine learning model can be a convolutional neural network. The instructions can further cause the processor to predict the likelihood that data entered in the electronic form field is sensitive data. Sensitive data can be deemed detected when the likelihood satisfies a predetermined threshold in one instance. Further, the instructions can cause the processor to contact a data steward with a request to classify data as sensitive or non-sensitive when the likelihood satisfies another predetermined threshold. The electronic form field can be presented on a webpage in one embodiment.

In accordance with another aspect, disclosed embodiments can include a method comprising executing, on a processor, instructions that cause the processor to perform operations. The operations include detecting entry of sensitive data in an electronic form field in real-time, determining a sensitive data type associated with the sensitive data, removing the sensitive data from the electronic form field, identifying context data surrounding removed sensitive data in the electronic form field, and training a machine learning model with the context data and sensitive data type to identify sensitive data. The operations can further comprise invoking the machine learning model to detect entry of the sensitive data, and detecting entry of the sensitive data comprises determining that a confidence score return by the machine learning model satisfies a predetermined threshold. In one instance, training the machine learning model can comprise updating the machine learning model with the context data and sensitive data type. The operations can further comprise invoking natural language processing to detect the entry of sensitive data. Further, the operations can comprise invoking pattern matching with regular expressions to detect the entry of the sensitive data based on a match. Furthermore, determining a sensitive data type can comprise classifying sensitive data as one of social security number, credit card number, name, or address.

According to yet another aspect, disclosed embodiments can include a computer-implemented method. The method can comprise invoking a machine learning model to detect entry of personal data in an electronic form field, determining a type of personal data, redacting the personal data from the electronic form field, identifying context data surrounding redacted personal data in the electronic form field, and retraining the machine learning model with the context data and the type of the personal data that improves predictive accuracy of detecting the personal data. The computer-implemented method can further comprise detecting entry of the personal data in a form field that is saved in an unencrypted or unobfuscated format. Further, the method can comprise performing pattern matching with regular expressions to determine the type of personal data. The method can also comprise detecting the entry of personal data when a confidence score provided by the machine learning model satisfies a predetermined threshold.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

The accompanying drawings, which are incorporated in and constitute a part of the specification, illustrate various example methods and configurations of various aspects of the claimed subject matter. It will be appreciated that the illustrated element boundaries (e.g., boxes, groups of boxes, or other shapes) in the figures represent one example of the boundaries. It is appreciated that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an overview of an example implementation.

FIG. 2 is a block diagram of a sensitive information monitoring system.

FIG. 3 is a block diagram of an example system using labeled sensitive information.

FIG. 4 is a block diagram of an example machine learning model.

FIG. 5 is a block diagram of another sensitive information monitoring system.

FIG. 6 is a flow chart diagram of a sensitive information monitoring method.

FIG. 7 is a flow chart diagram of another sensitive information monitoring method.

FIGS. 8A-B are flow chart diagrams of a training method for a machine learning model.

FIG. 9 is a block diagram illustrating a suitable operating environment for aspects of the subject disclosure.

### DETAILED DESCRIPTION

Now discussed are various example components and methods and other example configurations of several aspects of the subject disclosure. The aspects generally relate to identifying sensitive information (e.g., sensitive data) and creating improved models to more accurately detect sensitive information while or after an agent or financial institution client enters information into an electronic form, webpage, or the like. A sensitive information detection model can use a two-fold solution to leverage redacted data as part of training data. First, a machine learning model is used to understand the context around sensitive data. Second, regular expressions can be used to understand and analyze a dataset containing sensitive data and represent an understanding of sensitive data inner patterns. Combining these two solutions and training a final machine learning model on a previously human-labeled dataset creates a full understanding model that makes better predictions of what is or is not sensitive data.

A model created in this way enables the use of already redacted data sources for detection of sensitive data and to improve an existing regular-expression-based or machine learning solution. This aids in the solution of improperly captured sensitive human data entered at financial, business, and other databases each year. Improperly stored highly sensitive human information (e.g., sensitive information) comes from multiple origin sources such as agents, customers, engineers, third parties, and the like. Thus, there is a need to be able to detect this sensitive information to remediate actual sensitive information. However, data sources used to train models are finite, and sensitive data might already be masked or obscured. Developing a model that can use masked data for training enables an expanded amount of data for training datasets.

One example method for protecting sensitive information includes executing on a processor instructions that cause the processor to perform operations associated with protecting sensitive information. The operations include scanning for potential sensitive information within a data string or dataset specific to a user entering information into an electronic form where the potential sensitive information is associated with the user. The context surrounding the sensitive information is analyzed using a machine learning model. Regular expressions represent an understanding of the sensitive data inner patterns. The method may combine the analyzing the context surrounding the sensitive information and the using regular expressions to train the machine learning model on a human-labeled dataset, to create a final machine learning model that uses the context around the sensitive data and the using regular expressions to determine what is or is not sensitive data to create a machine learning model output. A data steward analyzes the machine learning model output, determines what is or is not sensitive data, and corrects what is sensitive information. The machine learning model can be trained on this corrected sensitive information to create a more accurate machine learning model.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

“Processor” and “Logic,” as used herein, include but are not limited to hardware, firmware, software, or combinations of each to perform a function(s) or an action(s), or to cause a function or action from another logic, method, or system to be performed. For example, based on a desired application or need, the logic or the processor may include a software-controlled microprocessor, discrete logic, an application specific integrated circuit (ASIC), a programmed logic device, a memory device containing instructions, or the like. The logic or the processor may include one or more physical gates, combinations of gates, or other circuit components. The logic or the processor may also be fully embodied as software. Where multiple logics or processors are described, it may be possible to incorporate the multiple logics or processors into one physical logic (or processor). Similarly, where a single logic or processor is described, it may be possible to distribute that single logic or processor between multiple physical logics or processors.

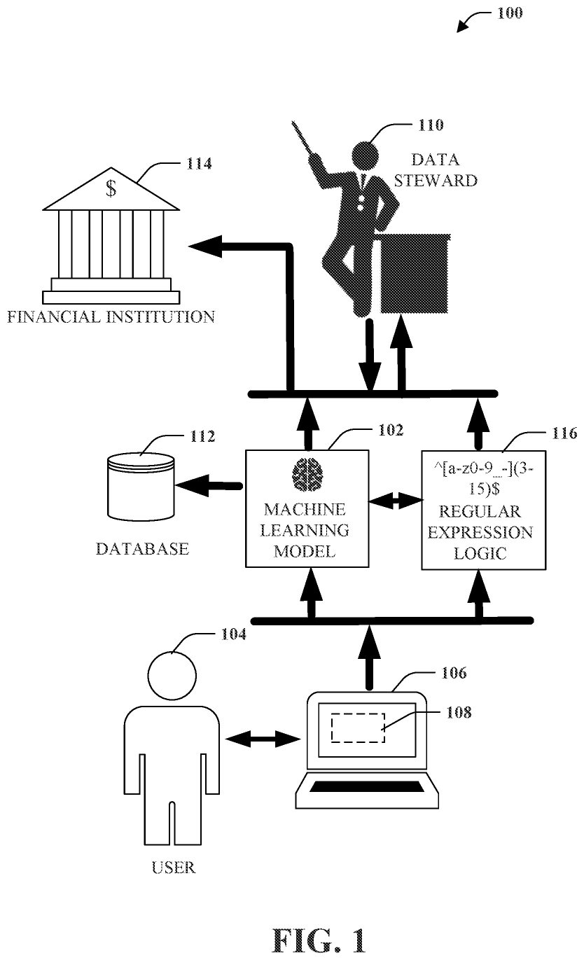

Referring initially to FIG. 1, a high-level overview of an example implementation of a system 100 for detecting sensitive information 108 using a machine learning model 102 as well as regular expression logic 116 is illustrated. Preferably the sensitive information 108 is recognized as sensitive by a human data steward and is properly encrypted or obfuscated at the time of file creation or updating. The encrypted or obfuscated data may then be labeled as a type of sensitive information that the sensitive data represents. It is much easier to preemptively prevent the inappropriate or incorrect use of sensitive information rather than trying to correct the inappropriate or incorrect user later.

This example system includes a user 104 entering information into a computer 106. The user 104 may be entering sensitive information 108 related to an online purchase, a financial transaction, an internet transaction, and the like. The computer 106 may be a laptop, tablet computer, mobile phone, or another electronic device. The user 104 may enter sensitive information 108, such as personally identifiable information (PII), into a form on the computer 106. The sensitive information 108 may be entered through a webpage, special form, and the like that may be provided to a financial institution, business, school, bank, church, or other organization.

As illustrated, the sensitive information 108 is input into a machine learning model 102 as part of a dataset, a string of data, or another form of data. Generally, a sensitive information detection model uses a two-fold solution to leverage redacted data as part of training data. First, the machine learning model 102 is used to understand the context around sensitive data (e.g., sensitive information). Second, regular expression logic 116 is used to understand and analyze a regular dataset that may contain sensitive data and represent an understanding of sensitive data inner patterns. By combining these two solutions and training a final machine learning model on a previously, at least partially, human-labeled dataset, a more fully understanding model is created that makes better predictions of what is or is not sensitive data. In some configurations, the machine learning model may use metadata surrounding the possible sensitive information when determining if the data is actually sensitive information.

In other configurations, the machine learning model 102 may determine a confidence value or a risk score of the sensitive data. The confidence value indicates how confident the machine learning model 102 is that data is sensitive. The machine learning model 102 may assign a low-risk score/confidence level to a dataset if it is not confident that the dataset contains sensitive information. When a low-risk score/confidence level is assigned, a human data steward 110 may manually review and correct the labeled sensitive information. The corrected labeled sensitive data may provide feedback to the machine learning model 102 so that the machine learning model 102 may improve its model for better performance in the future.

Catching sensitive information 108 that is incorrectly labeled in this way and having the sensitive information re-labeled properly before it is stored avoids violating national and international regulations protecting the safe handling of sensitive information. It is much better to correctly find sensitive information early and properly obscure the sensitive data early rather than after it makes its way into a data system. Final processed sensitive data may be sent to a database 112, a financial institution 114, a school, a business, or another location.

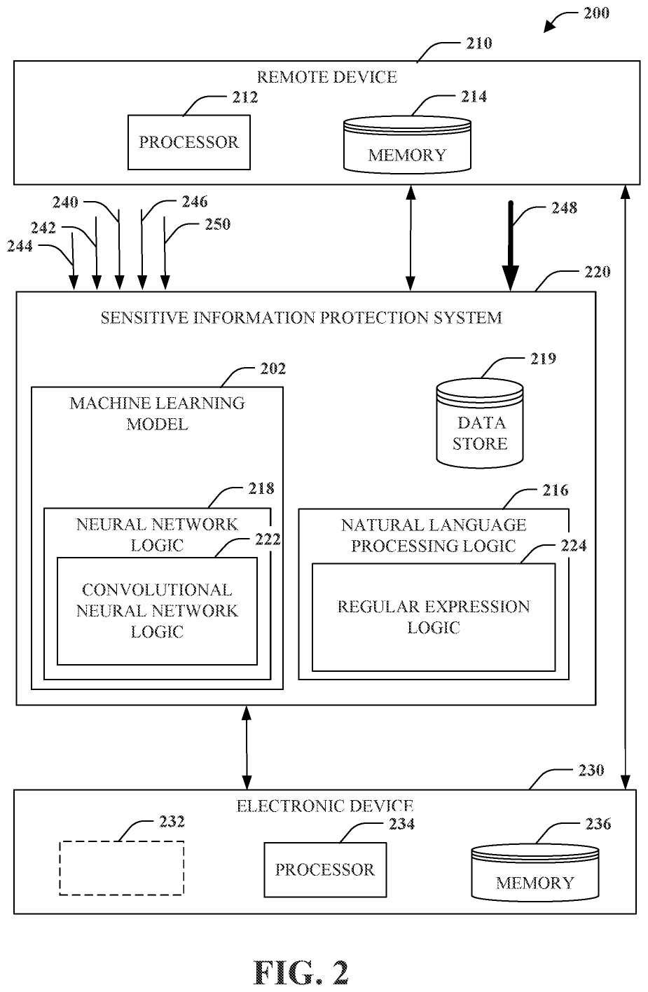

Turning attention to FIG. 2, an example sensitive information protection system 200 that protects sensitive information 232 is illustrated in further detail. First, the general concept of FIG. 2 is explained along with some of its functionality, then the details of FIG. 2 are explained. The example sensitive information protection system 200 includes a remote device 210, a sensitive information protection system 220, and an electronic device 230. The remote device 210 includes the remote device processor 212 and a memory 214. The sensitive information protection system 220 includes a machine learning model 202, a natural language processing (NLP) logic 216, and a data store 219. The machine learning model 202 includes a neural network logic 218 and a convolutional neural network logic 222. The NLP logic 216 includes a regular expression logic 224. The electronic device 230 includes an electronic device processor 234 as well as a memory 236.

The machine learning model 202, NLP logic 216, and the neural network logic 218 receive strings of data or datasets, or other blocks of data that include a variety of data, as discussed below. The datasets may include metadata 246 that may indicate if the data originated internal or external to an organization and the origin of the data. The metadata 246 may include any transformation of the data, a context around flagged sensitive information contained within the data, or volume of the data, among other things.

The sensitive information protection system 220 or portions of the sensitive information protection system 220 may be implemented with solid state devices such as transistors to create processors that implement functions that may be executed in silicon or other materials. Furthermore, the remote device processor 212 and the electronic device processor 234 may be implemented with general-purpose processors, digital signal processors (DSPs), application-specific integrated circuits (ASICs), field-programmable gate arrays (FPGAs), or other programmable logic devices, discrete gates or transistor logics, discrete hardware components, or any combination thereof designed to perform the functions described herein. A general-purpose processor may be a microprocessor, but in the alternative, the processor may be any processor, controller, microcontroller, or state machine. The remote device processor 212 and the electronic device processor 234 may also be implemented as a combination of computing devices, for example, a combination of a DSP and a microprocessor, a plurality of microprocessors, multi-core processors, one or more microprocessors in conjunction with a DSP core, or any other such configuration as understood by those of ordinary skill in the art.

In general, the example sensitive information protection system 200 uses the machine learning model 202 together with the NLP logic 216 to determine if sensitive information may actually be present in a dataset. In some embodiments, the machine learning model 202 together with the NLP logic 216 work in parallel, and each process the dataset to come to independent conclusions if sensitive information is present in the dataset. These two conclusions are then combined to determine if there is sensitive information present in the dataset. A primary input to the machine learning model 202 and the NLP logic 216 is the dataset 248 itself, which may or may not contains sensitive information. The dataset 248 is input to the sensitive information protection system 220 and then into the machine learning model 202 together with the NLP logic 216.

In one configuration, the sensitive information protection system 220 receives a dataset associated with a user entering information into an electronic form where the information may contain sensitive information. Of course, the data input may also include blocks of data or other forms of data that may contain sensitive information. The sensitive information is related to data that may identify a person, such as personally identifiable information (PII). PII may include a person's name, birth date, social security number, credit card number, driver's license number, and the like. The sensitive information protection system 220, the machine learning model 202, and the NLP logic 216 may also receive, associated with the dataset, the biometric behavior data 240, a user data 242 (e.g., customer data), an agent data 244, metadata 246, or an IP address 250. Along with the dataset, these inputs 240, 242, 244, 246, and 250 may be input to the machine learning model 202 and the NLP logic 216. All of these inputs be information useful to the machine learning model 202 for detecting sensitive information. Additionally, any notes about recoveries vs. acquisitions may also be used by the machine learning model 202 to locate sensitive information. An originating source internet protocol (IP) address 250 or a device type data when the data was captured may also be used by the machine learning model 202 to determine if sensitive information is present in the dataset. The machine learning model 202 may also use the biometric behavior data 240, the user data 242 (e.g., customer data), or the agent data 244 to determine if sensitive information is actually present in the dataset, string of data, or another form of data.

The machine learning model 202, in some instances, may use a metadata 246 associated with a dataset, dataset, block of data, or another data format. In some instances, the metadata 246 may include a flag/tag that indicates sensitive data may be present as well as any possible internal sources, external sources, as well as transformations of the data, and content around the flagged data of the metadata 246. All of this metadata of the dataset may indicate if sensitive information is present in the dataset.

The machine learning model 202 uses neural networks such as the neural network logic 218, which may use the convolutional neural network logic 222. In some instances, the convolutional neural network logic 222 may be a character-level convolutional neural network.

The NLP logic 216 may perform natural language processing on the dataset containing potential sensitive information and create an NLP context that is associated with data surrounding potential sensitive information. The NLP logic 216 uses regular expression logic 224 to determine if sensitive information is present in the dataset or around the dataset, such as a comment field. A variety of known implementations of NLP may be used as understood by those of ordinary skill in the art. For example, part-of-speech regular expression may introduce the use of hidden Markov models to natural language processing. Statistical models make soft, probabilistic decisions based on attaching real-valued weights to the features making up the input data. Cache language models upon which many speech recognition systems rely are examples of such statistical models.

Neural networks can also be implemented within the NLP logic 216. Some techniques include the use of “word embedding” to capture semantic properties of words, and an increase in end-to-end learning of a higher-level task (e.g., question answering) instead of relying on a pipeline of separate intermediate tasks (e.g., part-of-speech and dependency parsing). In another neural network technique, the term “neural machine translation” (NMT) emphasizes the fact that deep learning-based approaches to machine translation directly learn sequence-to-sequence transformations, obviating the need for intermediate steps such as word alignment and language modeling that may be used in statistical machine translation (SMT). Some neural network techniques tend to use non-technical structure of a given task to build a proper neural network.

It is to be appreciated that the regular expression logic 224 may use regular expressions (shortened as regex or regexp; also referred to as rational expression) to detect if sensitive information is present in a dataset. Short for regular expression, a regex is a string of text that allows you to create patterns that help match, locate, and manage text. Perl programming is an example of a programming language that utilizes regular expressions. However, Perl programming is only one of several places/programs where regular expressions can be found. Regular expressions can also be used from the command line and in text editors to find text within a file.

Regular expressions use a compact notation to describe the set of strings that make up a regular language. Regular expressions are a precise way of specifying a pattern that applies to all members of the set and may be particularly useful when the set has many elements. Regular expressions work on the principle of providing characters that need to be matched. For example, the regular expression cat would match the consecutive characters c-a-t. Regular expressions can be useful to programmers and can be used for a variety of tasks: (1) searching for strings, e.g., the word “needle” in a large document about haystacks, (2) implementing a “find and replace” function that locates a group of characters and replaces them with another group, and (3) validating user input, e.g., email addresses or passwords. A regular language can be defined as any language that can be expressed with a regular expression.

The machine learning model 202 is operable to analyze the input of sensitive information and compute a risk score and determine if the risk score crosses a threshold level (e.g., exceeds a threshold level). The risk score is a value that indicates the likelihood that an item on a form, website, or the like, was sensitive information that was entered incorrectly. In other words, the risk score is a value that captures the probability that sensitive information was entered incorrectly. For example, the machine learning model 202 can employ one or more rules to compute the risk score.

Various portions of the disclosed systems above, as mentioned, and methods below can include or employ artificial intelligence or knowledge or rule-based components, sub-components, processes, means, methodologies, or mechanisms (e.g., support vector machines, neural networks, expert systems, Bayesian belief networks, fuzzy logic, data fusion engines, classifiers, . . . ). Such components, among others, can automate certain mechanisms or processes performed thereby, making portions of the systems and methods more adaptive as well as efficient and intelligent. By way of example, and not limitation, the machine learning model 202 can employ such mechanisms to determine a risk score automatically (e.g., confidence value, confidence score) that is associated with the risk of sensitive information being placed in the wrong location or if the sensitive information should have been entered into a form or webpage at all.

The machine learning model 202 uses the input data discussed above and as well as additional data discussed below to determine if sensitive data is contained within the dataset (or datasets) with a predicted original source of the dataset. This allows for better tracking of where the dataset originated from. For example, the dataset may have originated from an application on a user's phone, originated from a customer agent's software, another customer agent tool, a customer or user of a financial institution's services, or another location. In some instances, the machine learning model 202 additionally assigns a risk score (e.g., confidence level) indicating whether sensitive information is present in a dataset or not. When the confidence level/risk score is lower than a threshold, human data stewards may manually accept or reject labeled sensitive information that has been redacted to improve future predictions. This is because when the machine learning model 202 has a similar new dataset that may contain sensitive information again, the machine learning model 202 uses this new knowledge to make a more informed decision.

In another configuration, customer agents may type notes that may be reviewed by subject matter experts or “data stewards.” The machine learning model 202 may detect whether a customer agent is typing sensitive data into a form field. Certain electronic form fields may be specifically checked where errors are often known to occur. For example, a field for entering an SSN may not be checked because the format of the field prevents errors. However, the subject line and free form note fields are checked. The customer agents may have a labeling workflow that the labeling team follows. There is a higher flow where there is a process where data scientists evaluate an agent's notes and teach a labeling team how to label an agent's data. Correctly labeled data by the labeling team are then used to train the machine learning model 202. Often, there are a bunch of iterations involving labeling the data by the labeling team and training the machine learning model 202.

Other configurations may contain other useful features and functionality. For example, there are two ways/parts of finding sensitive information that can differentiate and that are unique. First, the data is labeled and sampled as mentioned above. Second, once data is acquired, the data is modeled to provide an accurate estimation of if that data contains sensitive information. Past models use tree models, neural network models, and the like. In further detail, a stack for the “SSN is” may assign a number to each character that may receive a score if the character belongs to certain categories. When each character has been assigned to a category, the characters are combined at a broader level. The actual SSN may not be redacted until after training of the machine learning model 202. In the production model, the sensitive information/data is redacted. In production, when an agent enters an SSN, they may receive a message that they typed in an SSN, and the SSN is then redacted. For example, all of the SSN numbers may be replaced with asterisks.

As mentioned, the example system of FIG. 2 may attempt to remedy the incorrect placement or copying of sensitive information before the electronic document containing the sensitive information is created or stored. Preventing the violation of national or international regulations guarding the proper handling of the sensitive information may prevent violations and protect an organization's reputation.

In one example configuration, the remote device 210 and the electronic device 230 include the remote device processor 212 and an electronic device processor 234, as well as memory 214 and memory 236, respectively. The remote device processor 212 and the electronic device processor 234 may be implemented with solid state devices such as transistors to create processors that implement functions that it will appreciate that may be executed in silicon or other materials. Furthermore, the remote device processor 212 and the electronic device processor 234 may be implemented with general-purpose processors, digital signal processors (DSPs), application-specific integrated circuits (ASICs), field-programmable gate arrays (FPGAs), or other programmable logic devices, discrete gates or transistor logics, discrete hardware components, or any combination thereof designed to perform the functions described herein. A general-purpose processor may be a microprocessor, but in the alternative, the processor may be any processor, controller, microcontroller, or state machine. The remote device processor 212 and the electronic device processor 234 may also be implemented as a combination of computing devices, for example, a combination of a DSP and a microprocessor, a plurality of microprocessors, multi-core processors, one or more microprocessors in conjunction with a DSP core, or any other such configuration as understood by those of ordinary skill in the art.

The storage devices or memory 214 and memory 236 can be any suitable devices capable of storing and permitting the retrieval of data. In one aspect, the storage devices or memory 214 and memory 236 are capable of storing data representing an original website or multiple related websites. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The data store 219 can correspond to a persistent data structure (e.g., tables) accessible by the machine learning model 202. As such, a computing device is configured to be a special-purpose device or appliance that implements the sensitive information protection system 220. The data store 219 can be implemented in silicon or other hardware components so that the hardware or software can implement the functionality of the data store as described herein.

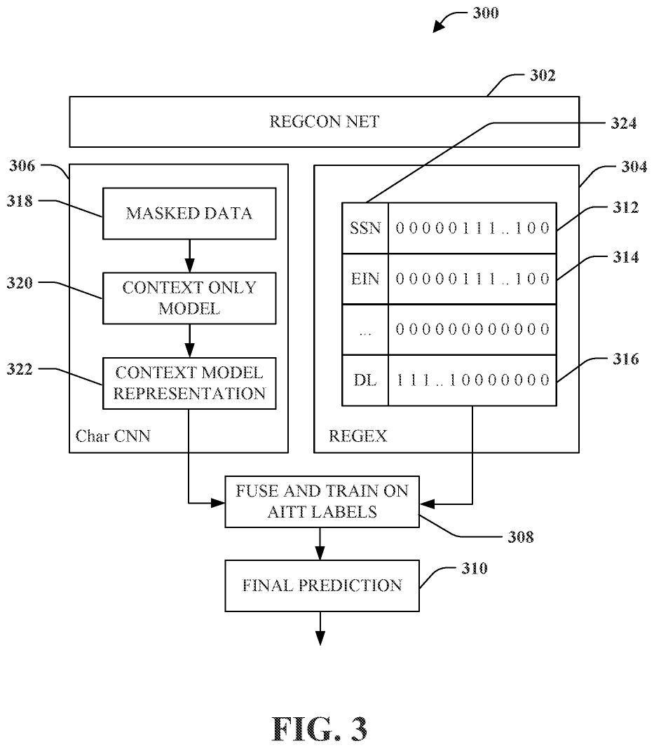

FIG. 3 illustrates an example label system 300 that may be a machine learning model that uses a character-level neural network (CNN) 306. A REGCON NET 302 overseas the injection of data into a regular expression (REGEX) unit 304 and the CNN 306. The illustrated regular expression unit 304 is illustrated with a social security number (SSN) 312 regular expression, an employee identification number (EIN) 314 regular expression, and a driver's license (DL) 316 regular expression. A label 324 of the masked data is attached to each of these regular expressions. Output(s) from the regular expression (REGEX) unit 304 are input to a fuse and train on artificial intelligence training team (AITT) labels unit 308. The AITT is a team of data stewards that create ideal AITT labels used to train the CNN 306.

The CNN 306 includes a first step of analyzing masked data 318. Output(s) from the analyzed mask data are input to a context-only model step 320. Output(s) from the context-only model representation step 322 are input to the fuse and train on the AITT labels unit 308. The AITT labels unit 308 fuses and trains on the AITT labels as well as the output(s) from the regular expression unit 304 and the output(s) from the context-only model representation step 322 to produce an output that is input to a final prediction unit 310. Output(s) from the final prediction unit 310 may be outputs of the machine learning model that indicate if the sensitive information labeled is actually sensitive information or not and what a risk score associated with the redacted sensitive information associated with a label.

One instance determines at least a portion of a confidence value with a CNN. Another instance determines a first risk score portion (e.g., first confidence value portion) with a CNN. Other operations are performed on regular expressions with the REGEX unit 304 to determine a second risk score portion. The first risk score portion and the second risk score portion are fused and trained with AITT labels to produce a final risk score.

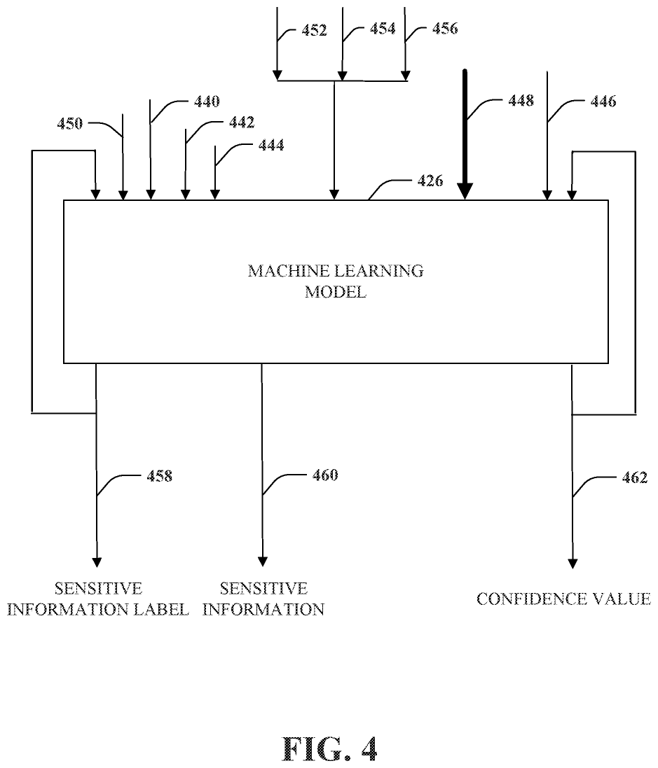

FIG. 4 depicts the machine learning model 426 in accordance with an example embodiment. The machine learning model 426 finds sensitive data in strings of data, datasets, blocks of data, and the like that contain sensitive information. The machine learning model 426 may also assign a confidence value 462 (e.g., risk score) to the found sensitive information. In another possible instance, the machine learning model 426 is used to prevent end computer system users from accidentally incorrectly inputting and submitting sensitive information. This helps to prevent users from incorrectly entering sensitive information at the source and eliminates the requirement of cleaning up incorrectly entered sensitive information after the sensitive information has already been committed to a form, stored in memory, or the like.

A dataset 448 that the machine learning model 426 is processing is a primary input of the machine learning model. Biometric behavior data 450 are also input to the machine learning model 426. Instead of looking at a profile of the person, biometric behavior captures a profile of the person's behavior profile. Non-biometric behavior data are also a primary input into the machine learning model 426. In general, non-biometric behavior data captures a profile unique to an individual. Non-biometric behavior data may include three types of data. This data includes user information 452 (or customer information), agent information 454, and digital interaction data 456. Metadata 440, as well as natural language processing (NLP) results 442, are also input into the machine learning model 426. Metadata 440 and NLP results 442 are data around the dataset, such as a comment field, any notes about recoveries vs. acquisitions may also be used by the machine learning model 426. An internet protocol (IP) address 444 is also input to the machine learning model 426, with the IP address 444 being a device type data when the data was captured that may also be used by the machine learning model 426 to determine if sensitive information is present in the dataset. Data steward feedback 446 is also input to the machine learning model. As mentioned above, data stewards can be humans that check labeled sensitive information with a low confidence value/level and correct or provide other feedback to the labeled data and the machine learning model 426.

The machine learning model 426 is trained on the data discussed above for labeling strings of data that contain sensitive information and produces a confidence value 462 associated with found sensitive data. In some instances, the machine learning model 426 may output a sensitive information label 458 that is assigned to redacted sensitive data. The machine learning model 426 may output what it considers sensitive information 460 that may need to be redacted. The machine learning model 426 also outputs a confidence value/risk score that indicates how confident the machine learning model 426 is that the sensitive information 460 is indeed sensitive data. Based on the confidence value, a human data steward may manually check the sensitive information 460 and associated sensitive information label 458 and accept or reject if this actually is sensitive information that needs to be redacted.

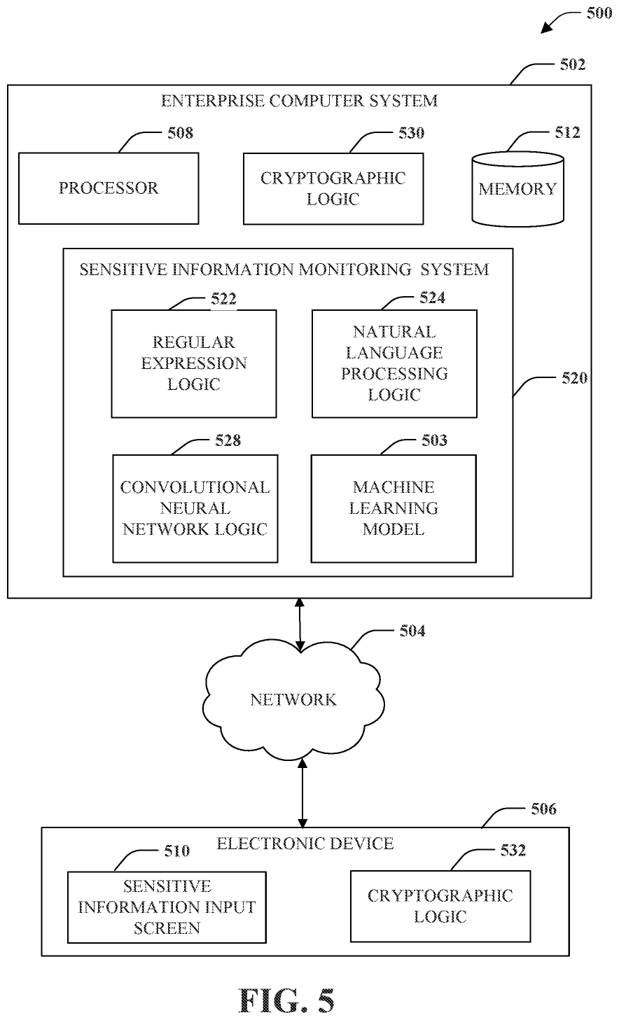

FIG. 5 illustrates another example system 500 for labeling sensitive information that was entered into an electronic form, website, an electronic device, and the like. The example system 500 includes an enterprise computer system 502, a network 504, and an electronic device 506. In some configurations, the sensitive information monitoring system 520 may, instead, be located in the electronic device 506.

The network 504 allows the enterprise computer system 502 and the electronic device 506 to communicate with each other. The network 504 may include portions of a local area network such as an Ethernet, portions of a wide area network such as the Internet, and may be a wired, optical, or wireless network. The network 504 may include other components and software as understood by those of ordinary skill in the art.

The enterprise computer system 502 includes a processor 508, cryptographic logic 530, a memory 512, and a sensitive information monitoring system 520. The processor 508 may be implemented with solid state devices such as transistors to create a processor that implements functions that one of ordinary skill in the art will appreciate are executed in silicon or other materials. Furthermore, the processor 508 may be implemented with a general-purpose processor, a digital signal processor (DSP), an application-specific integrated circuit (ASIC), a field-programmable gate array (FPGA), or another programmable logic device, discrete gates or transistor logics, discrete hardware components, or any combination thereof designed to perform the functions described herein.

The memory 512 can be any suitable device capable of storing and permitting the retrieval of data. In one aspect, the memory 512 is capable of storing sensitive information input to an electronic form, a website, software, or in another way. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The electronic device 506 includes a sensitive information input screen 510 and cryptographic logic 532. The sensitive information input screen 510 may be any suitable software such as a website page, electronic form, or another display on the electronic device 506 for entering sensitive information. In some embodiments, the sensitive information input screen 510 may include an audio input device such as a microphone that may be spoken into or any other device that captures a user's thoughts and that converts the thoughts into an electronic format.

Cryptographic logic 530 and cryptographic logic 532 in the enterprise computer system 502 and the electronic device 506, respectively, allow the enterprise computer system 502 and the electronic device 506 to send encrypted data including sensitive information and personally identifiable information (PII) between them. Cryptographic logic 530 and cryptographic logic 532 are operable to produce encrypted sensitive information by way of an encryption algorithm or function. The cryptographic logic 532 of the electronic device 506 can receive, retrieve, or otherwise obtain the sensitive information from the sensitive information input screen 510. An encryption algorithm is subsequently executed to produce an encrypted value representative of the encoded sensitive information. Stated differently, the original plaintext of the combination of encoded sensitive information is encoded into an alternate cipher text form. For example, the Advanced Encryption Standards (AES), Data Encryption Standard (DES), or another suitable encryption standard or algorithm may be used. In one instance, symmetric-key encryption can be employed in which a single key both encrypts and decrypts data. The key can be saved locally or otherwise made accessible by cryptographic logic 530 and cryptographic logic 532. Of course, an asymmetric-key encryption can also be employed in which different keys are used to encrypt and decrypt data. For example, a public key for a destination downstream function can be utilized to encrypt the data. In this way, the data can be decrypted downstream at a user device, as mentioned earlier, utilizing a corresponding private key of a function to decrypt the data. Alternatively, a downstream function could use its public key to encrypt known data.

The example system 500 may provide an additional level of security to the encoded data by digitally signing the encrypted sensitive information. Digital signatures employ asymmetric cryptography. In many instances, digital signatures provide a layer of validation and security to messages (i.e., sensitive information) sent through a non-secure channel. Properly implemented, a digital signature gives the receiver reason to believe the message was sent by the claimed sender.

Digital signature schemes, in the sense used here, are cryptographically based, and must be implemented properly to be effective. Digital signatures can also provide non-repudiation, meaning that the signer cannot successfully claim they did not sign a message while also claiming their private key remains secret. In one aspect, some non-repudiation schemes offer a timestamp for the digital signature, so that even if the private key is exposed, the signature is valid.

Digitally signed messages may be anything representable as a bit-string such as encrypted sensitive information. Cryptographic logic 530 and cryptographic logic 532 may use signature algorithms such as RSA (Rivest-Shamir-Adleman), which is a public-key cryptosystem that is widely used for secure data transmission. Alternatively, the Digital Signature Algorithm (DSA), a Federal Information Processing Standard for digital signatures, based on the mathematical concept of modular exponentiation and the discrete logarithm problem may be used. Other instances of the signature logic may use other suitable signature algorithms and functions.

The sensitive information monitoring system 520 includes a data string acquisition logic 522, a natural language processing logic 524, a machine learning model 503, and a convolutional neural network logic 528. The data string acquisition logic 522, the natural language processing logic 524, and the machine learning model 503 can be implemented by a processor coupled to a memory that stores instructions that, when executed, cause the processor to perform the functionality of each component or logic. The data string acquisition logic 522, the natural language processing logic 524, and the machine learning model 503 can be implemented in silicon or other hardware components so that the hardware or software can implement their functionality as described herein.

In one aspect, the data string acquisition logic 522 receives a dataset associated with a user entering information into an electronic form where the information may contain sensitive information. Of course, the data string acquisition logic 522 may alternatively receive datasets, blocks of data, or other forms of data that may contain sensitive information. The data string acquisition logic 522 also receives metadata associated with the dataset. In some instances, the data string acquisition logic 522 may receive biometric behavior data, non-biometric behavior user data, customer data, or agent data.

In another situation, the enterprise computer system 502 executes, on processor 508 instructions that cause the processor 508 to perform operations for finding sensitive information. The operations include receiving a dataset with redacted data associated with a user entering information into an electronic form where the redacted data is associated with sensitive information and is assigned a label associated with the sensitive information. The natural language processing logic 524 operates on the dataset to locate the sensitive information. A machine learning model 503 is invoked to use the convolutional neural network logic 528 to find the sensitive information. The NLP and CNN results are combined to predict if the sensitive information is present in the dataset. When training the machine learning model 503, feedback is accepted from a human data steward of whether the sensitive information, with its associated label, is present in the dataset. The feedback is used to train the machine learning model 503 on how to more accurately find the sensitive information in the dataset.

The aforementioned systems, architectures, platforms, environments, or the like have been described with respect to interaction between several logics and components. It should be appreciated that such systems and components can include those logics or components, or sub-components or sub-logics specified therein, some of the specified components or logics or sub-components or sub-logics, and/or additional components or logics. Sub-components could also be implemented as components or logics communicatively coupled to other components or logics rather than included within parent components. Further yet, one or more components or logics and/or sub-components or sub-logics may be combined into a single component or logic to provide aggregate functionality. Communication between systems, components, or logics and/or sub-components or sub-logics can be accomplished following either a push and/or pull control model. The components or logics may also interact with one or more other components not specifically described herein for the sake of brevity but known by those of skill in the art.

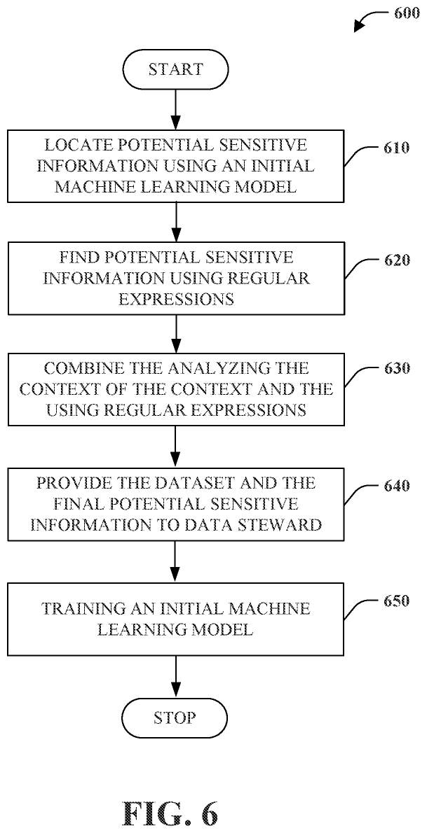

In view of the example systems described above, methods that may be implemented in accordance with the disclosed subject matter will be better appreciated with reference to flow chart diagrams of FIGS. 6-8. While for purposes of simplicity of explanation, the methods are shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 6, a method 600 for protecting sensitive information is depicted in accordance with an aspect of this disclosure. The method 600 for protecting sensitive information may execute instructions on a processor that cause the processor to perform operations associated with the method.

At reference number 610, the method 600 locates the potential sensitive information using an initial machine learning model. The sensitive information may first be located by analyzing regular expressions to find the potentially sensitive information within the dataset. The dataset is specific to a user entering information into an electronic form where the potential sensitive information is associated with the user. The method 600 may locate sensitive information that is personally identifiable information (PII). The sensitive information may be within a data string, data block, a packet, and the like.

Regular expressions are used, at reference numeral 620, to find the potentially sensitive information within the dataset. Regular expressions use a compact notation to describe the set of strings that make up a regular language. Regular expressions are a precise way of specifying a pattern that applies to all members of the set and may be particularly useful when the set has many elements. Regular expressions work on the principle of providing characters that need to be matched.

The method 600 combines, at reference numeral 630, analyzing the context surrounding the potentially sensitive information and using regular expressions. This combination is used to produce a final potential sensitive information. In some aspects, analyzing the context and using regular expressions occur in parallel. In other aspects, results from the combining the analyzing the context surrounding the sensitive information and the using regular expressions to produce a final potential sensitive information are fused together.

The dataset and the final potential sensitive information are provided, at reference numeral 640, to a human data steward to review and possible correction to create a correct dataset and a corrected possible sensitive information. An initial machine learning model is trained, at reference numeral 650, on the correct dataset and the corrected possible sensitive information, to create a trained machine learning model.

In other configurations, the initial machine learning model is triggered to determine a confidence value that indicates how likely the potentially sensitive information is correct. The confidence value, the analyzing the context surrounding the potentially sensitive information, and the using regular expressions are combined to produce the final potential sensitive information. In yet other instances, a convolutional neural network (CNN) is implemented within the initial machine learning model for finding potentially sensitive information. In other aspects, the operations further include using a character-level convolutional network (CNN) within the initial machine learning model for finding potentially sensitive information.

In other aspects, the operations further include scanning for sensitive information, that is, information the user enters into the electronic form on a webpage. The final potential sensitive information may be obfuscated before the final potential sensitive information is transmitted or stored so that the corrected possible sensitive information is not disclosed to third parties.

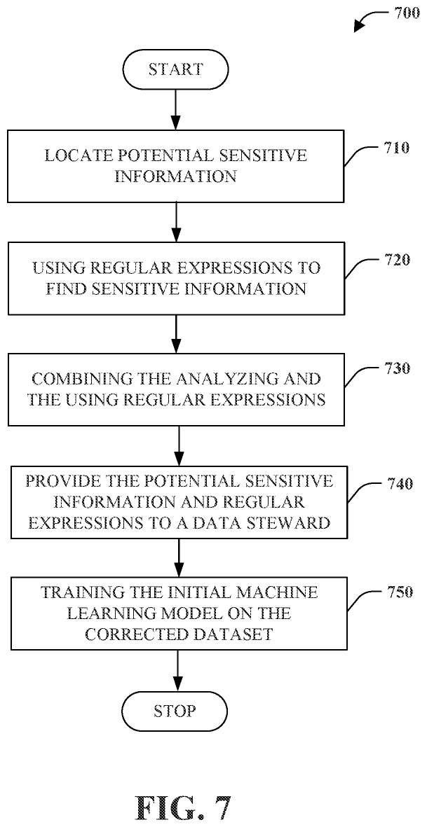

FIG. 7 depicts a computer-implemented method 700 for protecting sensitive information. The computer-implemented method 700 can be implemented and performed by the example sensitive information protection system 200 of FIG. 2 for protecting sensitive information using a machine learning model as well as regular expressions.

At reference numeral 710, the computer-implemented method 700 locates a piece of potentially sensitive information. The sensitive information may be located by analyzing a context surrounding the potentially sensitive information in a dataset using an initial machine learning model. The potentially sensitive information may be assigned a label. The dataset is specific to a user entering information into an electronic form where the potentially sensitive information is associated with the user. The potentially sensitive information may be data that is currently redacted from the dataset.

At reference numeral 720, regular expressions are used to find the potentially sensitive information within the dataset. The computer-implemented method 700 combines, at reference numeral 730, analyzing the context surrounding the potentially sensitive information and the using regular expressions to produce a final potential sensitive information. The dataset and the final potentially sensitive information are provided, at reference numeral 740, to a human data steward for review and possible correction to create a correct dataset and a corrected possible sensitive information.

The initial machine learning model is trained, at reference numeral 750, on the corrected dataset. The initial machine learning model may be trained on the corrected dataset and a corrected possible sensitive information, to create a trained machine learning model. A character-level convolutional network (CNN) within the initial machine learning model can be employed to find potentially sensitive information.

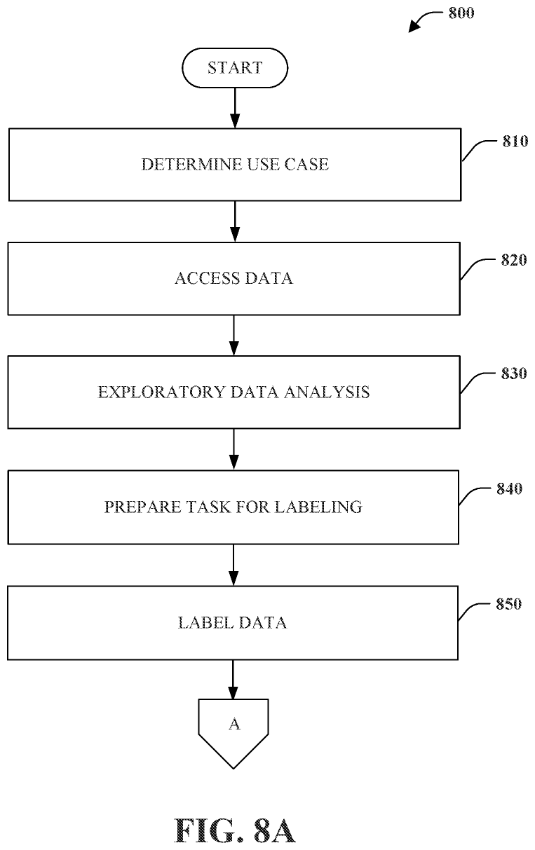

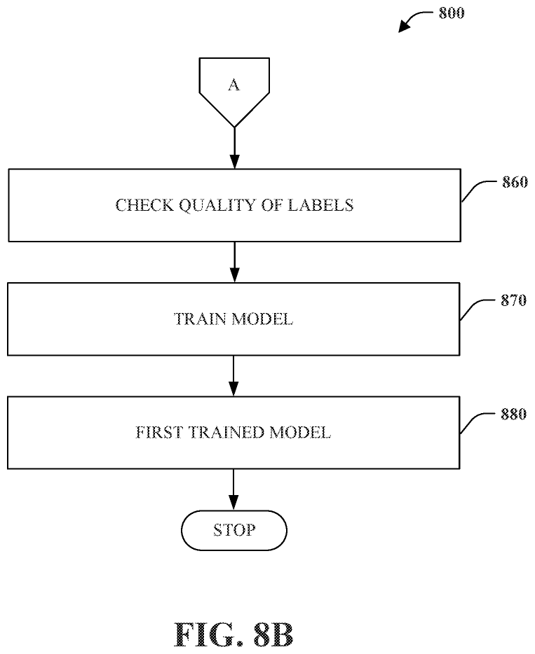

FIGS. 8A-B depict an example method 800 of protecting sensitive information. Initially, at reference number 810, a use case is decided on. After that, at reference numeral 820, data is accessed based on the use case selected. The example method 800 performs exploratory data analysis at reference numeral 830. After exploratory data analysis, the example method 800 prepares for the task of labeling data at reference number 840. The data is labeled at reference number 850, and the quality of the labels is checked at reference number 860. A machine learning model is trained at reference numeral 870, and a first trained model is created at reference label 880. Reference numbers 840, 850, and 860 may be executed by an artificial intelligence training team (AITT) with collaborative work with data scientists. The other blocks may be data scientists working without AITT involvement.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

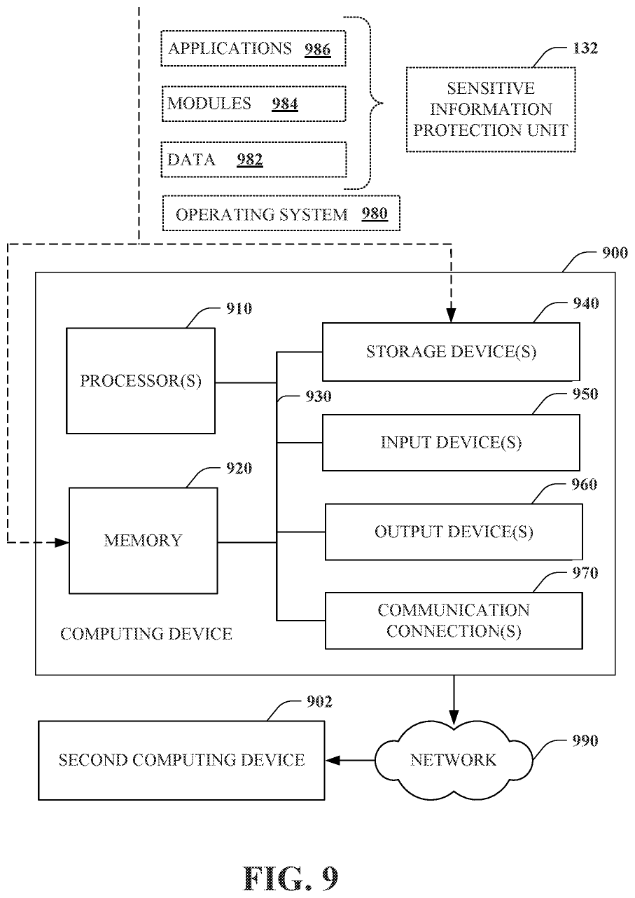

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node, . . . ). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example, a combination of a DSP and a microprocessor, a plurality of microprocessors, multi-core processors, one or more microprocessors in conjunction with a DSP core, or any other such configuration. In one configuration, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the sensitive information protection unit 220 can be, or form part of, the application 986, and include one or more program modules 984 and data 982 stored in memory and/or storage device(s) 940 whose functionality can be realized when executed by one or more processor(s) 910.

In accordance with one particular configuration, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the sensitive information protection unit 220 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth, . . . ), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In one instance, the computing device 900 can execute a sensitive information protection unit 220 for a first function, and the second computing device 902 can execute a sensitive information protection unit 220 for a second function in a distributed processing environment. Further, the second computing device can provide a network-accessible service that stores source code, and encryption keys, among other things that can be employed by the sensitive information protection unit 220 executing on the computing device 900.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to memory that includes instructions associated with protecting sensitive data that, when executed by the processor, cause the processor to:
detect entry of sensitive data in an electronic form field in substantially real-time;
determine a sensitive data type associated with the sensitive data;
redact the sensitive data from the electronic form field;
identify context data surrounding redacted sensitive data in the electronic form field; and
train a machine learning model with the context data and sensitive data type to identify sensitive data.

2. The system of claim 1, wherein the instructions further cause the processor to perform pattern matching to detect the entry of sensitive data into the electronic form field.

3. The system of claim 1, wherein the electronic form field is a freeform note field.

4. The system of claim 1, wherein the machine learning model detects the entry of the sensitive data in the electronic form field and is retrained with the context data and the sensitive data type.

5. The system of claim 4, wherein the machine learning model is a convolutional neural network.

6. The system of claim 1, wherein the instructions further cause the processor to predict a likelihood that data entered in the electronic form field is sensitive data.

7. The system of claim 6, wherein sensitive data is detected when the likelihood satisfies a predetermined threshold.

8. The system of claim 6, wherein the instructions further cause the processor to contact a data steward with a request to classify data as sensitive or non-sensitive when the likelihood satisfies a predetermined threshold.

9. The system of claim 1, wherein the electronic form field is presented on a webpage.

10. A method, comprising:
executing on a processor, instructions that cause the processor to perform operations associated, the operations comprising:
detecting entry of sensitive data in an electronic form field in real-time;
determining a sensitive data type associated with the sensitive data;
removing the sensitive data from the electronic form field;
identifying context data surrounding removed sensitive data in the electronic form field; and
training a machine learning model with the context data and sensitive data type to identify sensitive data.

11. The method of claim 10, wherein the operations further comprise invoking the machine learning model to detect entry of the sensitive data.

12. The method of claim 11, wherein detecting entry of the sensitive data comprises determining that a confidence score return by the machine learning model satisfies a predetermined threshold.

13. The method of claim 11, wherein training the machine learning model comprises updating the machine learning model with the context data and sensitive data type.

14. The method of claim 10, wherein the operations further comprise invoking natural language processing to detect entry of the sensitive data.

15. The method of claim 10, wherein the operations further comprise invoking pattern matching with regular expressions to detect entry of the sensitive data based on a match.

16. The method of claim 10, wherein determining a sensitive data type comprises classifying sensitive data as one of social security number, credit card number, name, or address.

17. A computer-implemented method, comprising:
invoking a machine learning model to detect entry of personal data in an electronic form field;
determining a type of personal data;
redacting the personal data from the electronic form field;
identifying context data surrounding redacted personal data in the electronic form field; and
retraining the machine learning model with the context data and the type of the personal data that improves predictive accuracy of detecting the personal data.

18. The computer-implemented method of claim 17, further comprising detecting entry of the personal data in a form field that is saved in an unencrypted or unobfuscated format.

19. The computer-implemented method of claim 17, further comprising performing pattern matching with regular expressions to determine the type of personal data.

20. The computer-implemented method of claim 17, further comprising detecting entry of the personal data when a confidence score provided by the machine learning model satisfies a predetermined threshold.
